(19) United States
(12) Patent Application Publication
(10) Pub. No.: US 2008/0091500 A1
(43) Pub. Date: Apr. 17, 2008

(54) SYSTEM AND METHOD TO CACHE CALENDAR SCHEDULE FOR OFFLINE SCHEDULING

(75) Inventors: Cynthia E. Barber-Mingo, Westford, MA (US); Gary Denner, Celbridge (IE); Ruthie D. Lyle, Durham, NC (US); Patrick J. O'Sullivan, Dublin (IE)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/537,871

(22) Filed: Oct. 2, 2006

(51) Int. Cl. G06F 15/02

(52) U.S. Cl. 705/9

(57) ABSTRACT

Systems and methods for caching calendar schedules for offline scheduling services. Exemplary embodiments include managing electronic calendar schedules, including caching information related to a group of users while connected to a network, defining a relationship with the group of users, selectively implementing a cache refresh rate for the cached information, using the cached information to schedule a proposed meeting while disconnected from the network, checking for conflicts between the proposed meeting and the schedules of the group of users while connected to the network, refreshing the cached information in response to conflicts and scheduling a revised meeting based on the refreshed cached information.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

The present disclosure relates generally to calendar applications, and, in particular, to systems and methods for caching calendar schedules for offline scheduling.

Electronic calendaring tools allow a meeting chairperson to schedule a meeting for multiple participants very easily. For example, a chairperson can arrange a meeting between multiple participants having access to the electronic calendaring tools. Although quite useful, the drawback to the calendaring solution is that the person arranging the meeting must be online to obtain schedule information for the persons being invited to the meeting. This schedule information can be visually relayed to the sender, where shaded time slots indicate a scheduled event.

### BRIEF SUMMARY

Embodiments of the invention include a computerized method for managing electronic calendar schedules, including caching information related to a group of users while connected to a network, defining a relationship with the group of users, selectively implementing a cache refresh rate for the cached information, using the cached information to schedule a proposed meeting while disconnected from the network, checking for conflicts between the proposed meeting and the schedules of the group of users while connected to the network, refreshing the cached information in response to conflicts and scheduling a revised meeting based on the refreshed cached information.

Additional embodiments include a method for managing electronic calendar schedules in a computer system having a graphical user interface including a display and a selection device, the method including displaying a list of users in fields on the display, managing a user schedule cache coupled to the computer system, including at least one of deleting users and adding users from the schedule cache, defining a time period for access to a user's schedule, selectively displaying a proposed meeting on the display, the meeting being scheduled based on schedules of the users from the cache and selectively revising the proposed meeting in response to schedule conflicts from one or more of the users.

Further embodiments include a computer readable medium having computer-executable instructions for performing a method, including caching information related to a group of users while connected to a network, defining a relationship with the group of users, selectively implementing a cache refresh rate for the cached information, using the cached information to schedule a proposed meeting while disconnected from the network, checking for conflicts between the proposed meeting and the schedules of the group of users while connected to the network, refreshing the cached information response to conflicts and scheduling a revised meeting based on the refreshed cached information.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is block diagram is a block diagram illustrating a system in which caching calendar schedules for offline scheduling services may be implemented in accordance with exemplary embodiments;

FIG. 2 is a flow diagram describing processes for implementing caching calendar schedules for offline scheduling services in exemplary embodiments; and

FIG. 3 depicts simplified block diagram of a user interface with sample data relating to a calendar program including caching calendar schedules for offline scheduling capabilities, the user interface utilized in implementing the caching calendar schedules for offline scheduling services in exemplary embodiments.

The detailed description explains the preferred embodiments of the invention, together with advantages and features, by way of example with reference to the drawings.

### DETAILED DESCRIPTION

Exemplary embodiments include a system and method that allows a meeting scheduler to cache schedule information for selected meeting participants defined by intelligent adaptive sensing that enables the scheduler to successfully schedule a meeting while disconnected from the network (offline). The systems and methods allow a meeting scheduler to have enough information about a selected list of participants (defined by intelligent adaptive sensing) such that she could successfully schedule a meeting while offline and disconnected from her peers on the network. If there is a conflict due to an unexpected change in a participant's schedule, the cache for the participant with the conflict would be refreshed and the information used to reschedule the meeting. Organizational distance schemes to automatically select/remove potential meeting participants, for which schedule information can be cached, can also be implemented.

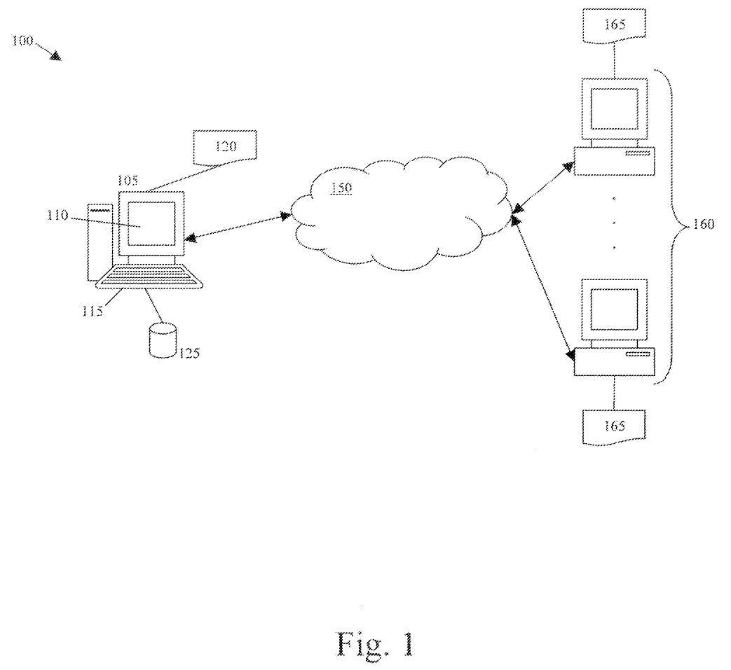

FIG. 1 is block diagram is a block diagram illustrating a system 100 in which caching calendar schedules for offline scheduling services may be implemented in accordance with exemplary embodiments. System 100 generally includes a chairperson computer 105, having a display 110 and input/section device 115, which can be a keyboard, mouse, combinations thereof, etc. Chairperson computer 105 is connectable to network 150. A series of user computers 160, each having a calendar application 165, are coupled to network 150. In general, as discussed further in the description below, chairperson computer includes application 120 for caching calendar schedules for offline scheduling services. As such, chairperson computer 105 is capable of scheduling events such as meetings while offline by retaining cached information in a storage medium 125 that is actively and adaptively collected while chairperson computer is connected to network 150.

As discussed, chairperson computer 105 includes functionality that allows a chairperson to cache schedule information in storage medium 125 for potential meeting participants while she is online. The granularity/detail of the cached information could be based on the relationship between the chairperson and each of the participants, having user computers 160. As appropriate information could be cached for varying periods of time, for example, for a week, a month or a year or other suitable periods. Other subsets of time periods could also be implemented, for example only Monday to Wednesday of each week for 2 months. A cache refresh rate could then be defined with respect to, but not limited to: the relationship between the chairperson and participants, defined by the chairperson for specific participant(s), or could be triggered by a calendar actions (for example a change in the participant's calendar).

The chairperson, while disconnected from the network 150, would then use the cached participant information from storage medium 125 to schedule a “proposed” meeting. When the chairperson connected to the network 150 again, the meeting would be added to the participants's calendar applications 165. If there is a conflict (due to an unexpected change in a participant's schedule) the cache for the participant with the conflict would be refreshed and the information used to reschedule the meeting. The chairperson would be prompted to select another time slot manually or intelligence could be added to the application to automate the reschedule of the meeting. In general, the cache is a file or other repository of schedule/availability information that would be updated frequently and discarded when no longer relevant. In addition, the cache can periodically be dumped. In dumping the cache, the cache data is discarded automatically when the cache is refreshed. In addition, a “keep-alive” feature could be defined that allows the cache to be dumped before the next expected refresh.

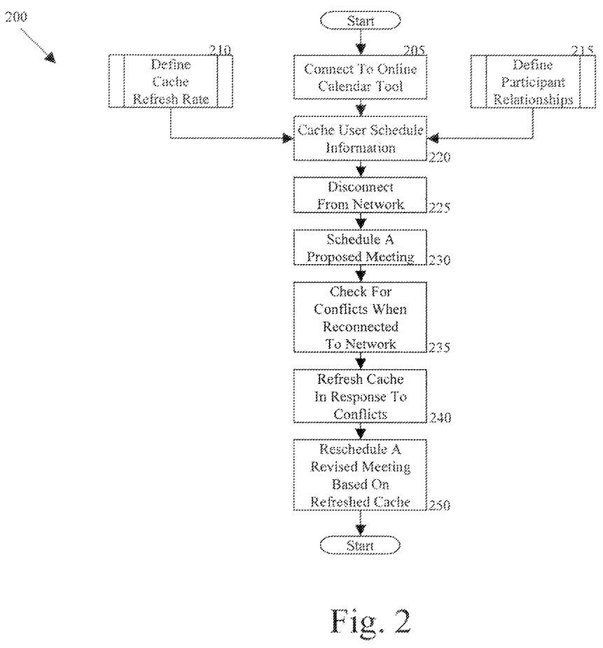

FIG. 2 is a flow diagram describing a process 200 for implementing caching calendar schedules for offline scheduling services in exemplary embodiments. In general, at step 205, chairperson connects to network 150 and to online calendar tool, application 120. As discussed above, a cache rate can be defined at step 210 and participants' relationships can be defined at step 215. There are many examples of relationship definitions that can exist between the chairperson and participant(s) (which can be logically combined), including but not limited to: no special relationship basic/default relationship; participants on the chairperson's instant message (IM) buddy list—IM relationship; special relationship in the enterprise hierarchy—enterprise relationship; participant is active in the chairperson' mail queue—email relationship; participant has frequent presence on the user's calendar—calendar relationship; and participant has been defined by the user to be “selected” to receive custom information—customized, etc. There may be occasions when the user wishes to override the cache rate based on a relationship. These occasions have practical application when there may be an interaction that can supercede the relationship. For example a person is working on a project that has a deadline in two weeks, but the refresh rate associated with the relationship is not frequent enough.

At step 220, user (calendar and schedule) information is cached, generally to storage medium 125. At sometime, the chairperson may disconnect from the network at step 225. At that time, the chairperson may schedule a proposed meeting, while offline, at step 230. The chairperson could then reconnect to the network 150. At that time, at step 235, the chairperson can check for schedule conflicts related to the proposed meeting. When conflicts have been resolved, it is appreciated that the cache can be refreshed 240 to represent new patterns of scheduling that may exist between the chairperson and the other participants. As such, when the cache is refreshed, the chairperson has a new cache of information that can be utilized in future schedules while offline. In this way, the cached information is adaptive, allowing for better and better accuracy in scheduling meetings while offline. At step 250, a new meeting can be proposed based on the refreshed cache.

In general, although process 200 defines a series of steps in order, it is understood that the steps may occur at different times and that the connection and disconnection to network 150 may occur at different times.

It is therefore appreciated that intelligent sensing of the user's environment is a catalyst to keeping the user's cache relevant. For example, if user adds a person to their buddy list (in a folder that they deem important) then the user's cache can be updated automatically (or via user preference/prompting) with this new user. Likewise, when a user is inserted in to the employee's team (e.g. new employee, new manager) the calendar information is also cached for this purpose. In an exemplary embodiment, organizational distance is applied to an abstraction that is based on the scheduler's lightweight directory access protocol (LDAP) tree (organizational distance can therefore be user configurable), thereby furnishing a list of individuals that are automatically cached for the scheduler. In another exemplary embodiment, reciprocal is also true. Therefore, when a person leaves the tree, the user is automatically prompted with a view to removing them. Information/patterns in the scheduler's mailbox can contribute to prompted requests to add a new users to the cache, for example—if a pattern emerges that a user is frequently emailing or in calendar events with User A, then this pattern can force an auto-prompt such that calendar information for Person A is added to the user's cache. Other patterns that define implicit relationships can also be defined. For example, if a pattern is formed where User A experiences a number of IM conversations with User B (threshold is user defined) then automatic prompting to cache this user would take place.

Therefore, a user interface that manages the users cache, for example, to delete users (in a persistent or non persistent way), add users, (in a persistent or non persistent way), to arbitrarily define the time-span/range on a per-user basis (e.g., a user wants User A's calendar data for 3 months in to the future. User B's calendar for a year in to the future, User C's for a week), etc. A user interface can further be implemented to manage relevant patterns and relationships.

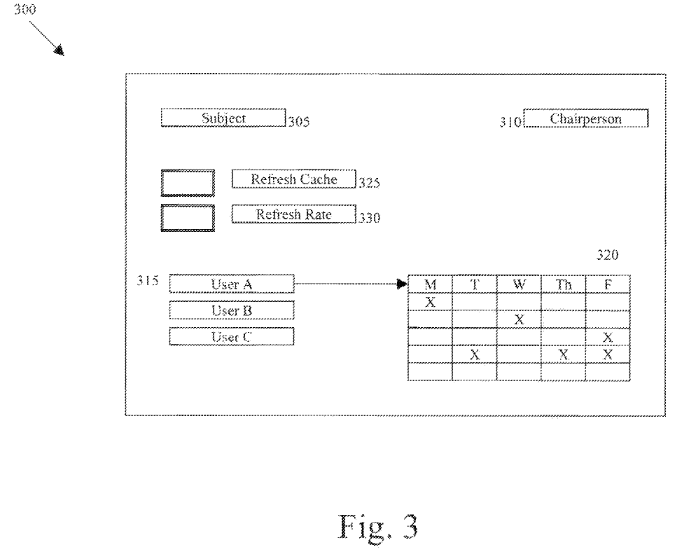

FIG. 3 depicts simplified block diagram of a user interface 300 with sample data relating to a calendar program including caching calendar schedules for offline scheduling capabilities, the user interface utilized in implementing the caching calendar schedules for offline scheduling services in exemplary embodiments. The methods described above can be implemented via user interface 300. User interface 300 can include a subject line 305 and chairperson field 310, which would define where cached information could be stored. User interface 300 can further include User fields 315 into which desired participants and related schedules 320 can be displayed. As discussed above, user interface 300 can be accessed when the user is online or offline. Whether online or offline, any user information that has been provided by the relationships as described above, conflict resolutions, etc., the cache information can be refreshed via control 325. A refresh rate can also be defined via refresh rate control 330. In other exemplary embodiments, other functionality and controls as described above can be further included on user interface 300.

As discussed above, embodiments can be embodied in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A computerized method for managing electronic calendar schedules, comprising:
caching information related to a group of users while connected to a network;
defining a relationship with the group of users;
selectively implementing a cache refresh rate for the cached information;
using the cached information to schedule a proposed meeting while disconnected from the network;
checking for conflicts between the proposed meeting and the schedules of the group of users while connected to the network;
refreshing the cached information in response to conflicts; and
scheduling a revised meeting based on the refreshed cached information.

2. The method as claimed in claim 1 further comprising using the refreshed cached information to schedule future proposed meetings while disconnected from the network.

3. The method as claimed in claim 1 wherein the relationship is defined by at least one of: an instant messenger list; an email list; an enterprise relationship; and a frequent presence on a user's calendar.

4. The method as claimed in claim 3 further comprising overriding the cache refresh rate in response to defining a relationship having a frequency falling into a time period less than the refresh rate period.

5. The method as claimed in claim 1 further comprising updating the cached information in response to adding a user.

6. In a computer system having a graphical user interface including a display and a selection device, a method for managing electronic calendar schedules, the method comprising:
displaying a list of users in fields on the display;
managing a user schedule cache coupled to the computer system, including at least one of deleting users and adding users from the schedule cache;
defining a time period for access to a user's schedule;
selectively displaying a proposed meeting on the display, the meeting being scheduled based on schedules of the users from the cache; and
selectively revising the proposed meeting in response to schedule conflicts from one or more of the users.

7. The method as claimed in claim 6 further comprising scheduling the proposed meeting when the computer system is disconnected from a network, to which the users have access.

8. The method as claimed in claim 7 further comprising checking for the scheduling conflicts when the computer system is connected to the network and all user schedules can be adapted to one another.

9. The method as claimed in claim 8 further comprising refreshing the cache in response to the scheduling conflicts.

10. The method as claimed in claim 6 further comprising generating a prompt on the display in response to patterns in the computer system.

11. The method as claimed in claim 10 wherein the prompt solicits a response to a request including at least one of adding or deleting a user.

12. The method as claimed in claim 11 wherein scheduling patterns include at least one of: frequently emailing to a user; frequently scheduling events with a user; frequently instant massaging a user; and a change of business relationship among users.

13. The method as claimed in claim 6 wherein the deleting and adding of users from the schedule cache occurs in response to a selection signal indicative of the selection device pointing at a selected field.

14. The method as claimed in claim 6 further comprising the time period for access to a user's schedule in a field on the display.

15. The method as claimed in claim 14 further comprising:
receiving a selection signal indicative of the selection device pointing at the time period for access to a user's schedule field; and
in response to the selection signal, performing a modification to the definition of the time period for access to a user's schedule.

16. A computer readable medium having computer-executable instructions for performing a method, comprising:
caching information related to a group of users while connected to a network;
defining a relationship with the group of users;
selectively implementing a cache refresh rate for the cached information;
using the cached information to schedule a proposed meeting while disconnected from the network;
checking for conflicts between the proposed meeting and the schedules of the group of users while connected to the network;
refreshing the cached information in response to conflicts; and
scheduling a revised meeting based on the refreshed cached information.

17. The computer readable medium as claimed in claim 16, wherein the method further comprises:
displaying a list of users in fields on a computer display connected to a computer system;
managing a user schedule cache having the cached information and coupled to the computer system, managing the user cache including at least one of deleting users and adding users from the schedule cache;
defining a time period related to the refresh rate for access to a user's schedule; and
selectively displaying a proposed meeting on the display, the meeting being scheduled based on schedules of the users from the cache.
